(19) United States
(12) Patent Application Publication
(10) Pub. No.: US 2011/0054833 A1
(43) Pub. Date: Mar. 3, 2011

(54) PROCESSING MOTION SENSOR DATA USING ACCESSIBLE TEMPLATES

(75) Inventor: Andrea Mucignat, Burlingame, CA (US)

(73) Assignee: Apple Inc., Cupertino, CA (US)

(21) Appl. No.: 12/552,377

(22) Filed: Sep. 2, 2009

(51) Int. Cl. G01C 22/00; G06F 15/00

(52) U.S. Cl. 702/150; 73/865.4

(57) ABSTRACT

Systems and methods for processing motion sensor data using data templates accessible to an electronic device are provided. Each data template may include template sensor data and template event data. Template sensor data of one or more templates may be compared by the electronic device to motion sensor data generated by a motion sensor. A particular template may be distinguished based on the similarity between the motion sensor data and the template sensor data of the particular template. The template event data of the distinguished particular template may then be used to control a function of the electronic device. The motion sensor data and/or the template sensor data may be associated with a user stepping event, and the template event data of the distinguished particular template may then be used to record the occurrence of the stepping event to track a user's workout history.

### FIELD OF THE INVENTION

This can relate to systems and methods for processing motion sensor data and, more particularly, to systems and methods for processing motion sensor data using accessible data templates.

### BACKGROUND OF THE DISCLOSURE

Electronic devices, and in particular portable electronic devices, often include one or more sensors for detecting characteristics of the device and its surroundings. For example, an electronic device may include one or more motion sensors, such as an accelerometer or gyroscope, for detecting the orientation and/or movement of the device. The electronic device may process the data generated by the motion sensors and may be operative to perform particular operations based on the processed motion sensor data. For example, an electronic device may process motion sensor data to determine the number of steps taken by a user carrying the device. However, the effectiveness of this processing often varies based on the positioning of the one or more motion sensors with respect to the user.

### SUMMARY OF THE DISCLOSURE

Systems, methods, and computer-readable media for processing motion sensor data using accessible data templates are provided.

For example, in some embodiments, there is provided an electronic device that may include a motion sensor and a processor. The processor may be configured to receive motion sensor data generated by the motion sensor and to access templates. Each template may include template sensor data and template event data. The processor may also be configured to distinguish a particular template from the accessed templates based on the similarity between the received motion sensor data and the template sensor data of the particular template. Moreover, the processor may be configured to control a function of the electronic device based on the template event data of the particular template.

In other embodiments, there is provided a method for generating motion sensor templates. The method may include inducing an entity to perform a first type of motion event while carrying a motion sensor in a first position. The method may then receive first motion sensor data generated by the motion sensor in response to the motion sensor detecting movement caused by the performance of the first type of motion event. A first motion sensor template may then be generated by creating a template sensor data portion of the first motion sensor template with the first motion sensor data, and by creating a template event data portion of the first motion sensor template based on the first type of motion event. Additionally, for example, a template position data portion of the first motion sensor template may be created based on the first position.

A second motion sensor template may then be generated. For example, the method may also include inducing the entity to re-perform the first type of motion event while carrying the motion sensor in a second position. The method may then receive second motion sensor data generated by the motion sensor in response to the motion sensor detecting movement caused by the re-performance of the first motion event. The second motion sensor template may then be generated by creating a template sensor data portion of the second motion sensor template with the second motion sensor data, and by creating a template event data portion of the second motion sensor template that is the same as the template event data portion of the first motion sensor template.

### BRIEF DESCRIPTION OF THE DRAWINGS

The above and other aspects of the invention, its nature, and various features will become more apparent upon consideration of the following detailed description, taken in conjunction with the accompanying drawings, in which like reference characters refer to like parts throughout, and in which:

FIG. 1 is a schematic view of an illustrative electronic device in accordance with some embodiments of the invention;

FIG. 2 is a schematic view of an illustrative motion sensor in accordance with some embodiments of the invention;

FIG. 3 is a schematic view of an illustrative graph of motion sensor output over time in accordance with some embodiments of the invention;

FIG. 4 is a schematic view of an illustrative graph of the magnitude of the motion in accordance with some embodiments of the invention;

FIG. 5 is a schematic view of an illustrative graph of the magnitude of the motion after eliminating the effect of gravity in accordance with some embodiments of the invention;

FIG. 6 is a schematic view of an illustrative graph of the rectified magnitude of the motion after eliminating the effect of gravity in accordance with some embodiments of the invention;

FIG. 7 is schematic view of a portion of the electronic device of FIG. 1 in accordance with some embodiments of the invention;

FIG. 8 is a front view of a user carrying various portions of electronic devices in accordance with some embodiments of the invention;

FIG. 9 is a flowchart of an illustrative process for processing motion sensor data in accordance with some embodiments of the invention; and

FIG. 10 is a flowchart of an illustrative process for generating motion sensor templates in accordance with some embodiments of the invention.

### DETAILED DESCRIPTION OF THE DISCLOSURE

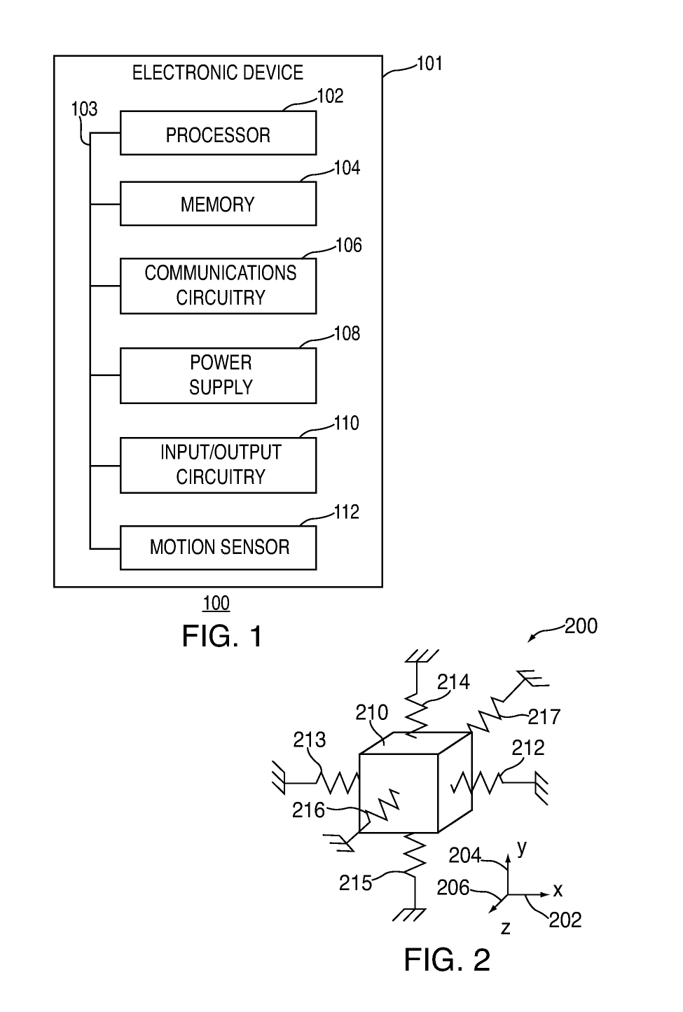

Systems, methods, and computer-readable media for processing motion sensor data using accessible data templates are provided and described with reference to FIGS. 1-10.

An electronic device may be operative to receive motion sensor data generated by a motion sensor and the motion sensor data may be used to control a function of the electronic device. For example, a user of the device may perform a certain motion event (e.g., a walking event or a shaking event) that may cause the motion sensor to detect a particular movement and thereby generate particular motion sensor data. However, a particular motion event performed by the user may result in different motion sensor data being generated if the position of the sensor with respect to the user is varied (e.g., between the sensor being held in a user's hand and in a user's pocket). Therefore, one or more motion sensor templates are made accessible to the device and used to help process motion sensor data generated by a motion sensor for distinguishing the type of user motion event associated with the motion sensor data.

Each motion sensor template may include template sensor data indicative of a motion sensor data output profile for a certain user motion event performed with a certain sensor position. Each motion sensor template may also template event data describing the type of motion event associated with the template and template position data describing the sensor position associated with the template. Multiple templates associated with the same motion event may be created based on multiple sensor positions, and multiple templates associated with the same sensor position may be created based on multiple motion event types. A collection of templates may be made accessible to the device during motion sensor data processing.

When new motion sensor data is generated, the electronic device may distinguish a particular template from the accessible templates based on the similarity between the motion sensor data and the template sensor data of the particular template. For example, the device may compare the motion sensor data to the template sensor data of one or more accessible templates and may identify the particular template based on a similarity value determined during the comparison process. Once a particular template has been distinguished as having template sensor data particularly similar to the motion sensor data, the device may use the template event data of that particular template to potentially control a function of the device.

FIG. 1 is a schematic view of an illustrative electronic device 100 for detecting a user's steps using one or more motion sensors in accordance with some embodiments of the invention. Electronic device 100 may perform a single function (e.g., a device dedicated to detecting a user's steps) and, in other embodiments, electronic device 100 may perform multiple functions (e.g., a device that detects a user's steps, plays music, and receives and transmits telephone calls). Moreover, in some embodiments, electronic device 100 may be any portable, mobile, or hand-held electronic device configured to detect a user's steps wherever the user travels. Electronic device 100 may include any suitable type of electronic device having one or more motion sensors operative to detect a user's steps. For example, electronic device 100 may include a media player (e.g., an iPod™ available by Apple Inc. of Cupertino, Calif.), a cellular telephone (e.g., an iPhone™ available by Apple Inc.), a personal e-mail or messaging device (e.g., a Blackberry™ available by Research In Motion Limited of Waterloo, Ontario), any other wireless communication device, a pocket-sized personal computer, a personal digital assistant (“PDA”), a laptop computer, a music recorder, a still camera, a movie or video camera or recorder, a radio, medical equipment, any other suitable type of electronic device, and any combinations thereof.

Electronic device 100 may include a processor or control circuitry 102, memory 104, communications circuitry 106, power supply 108, input/output (“I/O”) circuitry 110, and one or more motion sensors 112. Electronic device 100 may also include a bus 103 that may provide a data transfer path for transferring data, to, from, or between various other components of device 100. In some embodiments, one or more components of electronic device 100 may be combined or omitted. Moreover, electronic device 100 may include other components not combined or included in FIG. 1. For example, electronic device 100 may also include various other types of components, including, but not limited to, light sensing circuitry, camera lens components, or global positioning circuitry, as well as several instances of one or more of the components shown in FIG. 1. For the sake of simplicity, only one of each of the components is shown in FIG. 1.

Memory 104 may include one or more storage mediums, including, for example, a hard-drive, solid-state drive, flash memory, permanent memory such as read-only memory (“ROM”), semi-permanent memory such as random access memory (“RAM”), any other suitable type of storage component, or any combination thereof. Memory 104 may include cache memory, which may be one or more different types of memory used for temporarily storing data for electronic device applications. Memory 104 may store media data (e.g., music, image, and video files), software (e.g., for implementing functions on device 100), firmware, preference information (e.g., media playback preferences), lifestyle information (e.g., food preferences), exercise information (e.g., information obtained by exercise monitoring equipment), transaction information (e.g., information such as credit card information), wireless connection information (e.g., information that may enable device 100 to establish a wireless connection), subscription information (e.g., information that keeps track of podcasts or television shows or other media a user subscribes to), contact information (e.g., telephone numbers and e-mail addresses), calendar information, any other suitable data, or any combination thereof.

Communications circuitry 106 may be provided to allow device 100 to communicate with one or more other electronic devices or servers (not shown) using any suitable communications protocol. For example, communications circuitry 106 may support Wi-Fi (e.g., an 802.11 protocol), Ethernet, Bluetooth™, high frequency systems (e.g., 900 MHz, 2.4 GHz, and 5.6 GHz communication systems), cellular networks (e.g., GSM, AMPS, GPRS, CDMA, EV-DO, EDGE, 3GSM, DECT, IS-136/TDMA, iDen, LTE, or any other suitable cellular network or protocol), infrared, transmission control protocol/internet protocol (“TCP/IP”) (e.g., any of the protocols used in each of the TCP/IP layers), hypertext transfer protocol (“HTTP”), BitTorrent™, file transfer protocol (“FTP”), real-time transport protocol (“RTP”), real-time streaming protocol (“RTSP”), secure shell protocol (“SSH”), voice over internet protocol (“VoIP”), any other communications protocol, or any combination thereof. Communications circuitry 106 may also include circuitry that can enable device 100 to be electrically coupled to another device (e.g., a computer or an accessory device) and communicate with that other device, either wirelessly or via a wired connection.

Power supply 108 may provide power to one or more of the other components of device 100. In some embodiments, power supply 108 can be coupled to a power grid (e.g., when device 100 is not acting as a portable device or when it is being charged at an electrical outlet). In some embodiments, power supply 108 can include one or more batteries for providing power (e.g., when device 100 is acting as a portable device). As another example, power supply 108 can be configured to generate power from a natural source (e.g., solar power using solar cells).

Input/output circuitry 110 may be operative to convert, and encode/decode, if necessary, analog signals and other signals into digital data. In some embodiments, I/O circuitry 110 may convert digital data into any other type of signal, and vice-versa. For example, I/O circuitry 110 may receive and convert physical contact inputs (e.g., using a multi-touch screen), physical movements (e.g., using a mouse or sensor), analog audio signals (e.g., using a microphone), or any other input. The digital data can be provided to and received from processor 102, memory 104, or any other component of electronic device 100. Although I/O circuitry 110 is illustrated in FIG. 1 as a single component of electronic device 100, several instances of I/O circuitry can be included in electronic device 100.

Input/output circuitry 110 may include any suitable mechanism or component for allowing a user to provide inputs for interacting or interfacing with electronic device 100. For example, I/O circuitry 110 may include any suitable user input component or mechanism and can take a variety of forms, including, but not limited to, an electronic device pad, dial, click wheel, scroll wheel, touch screen, one or more buttons (e.g., a keyboard), mouse, joy stick, track ball, and combinations thereof. In some embodiments, I/O circuitry 110 may include a multi-touch screen. Each input component of I/O circuitry 110 can be configured to provide one or more dedicated control functions for making selections or issuing commands associated with operating electronic device 100.

Input/output circuitry 110 may also include any suitable mechanism or component for presenting information (e.g., textual, graphical, audible, and/or tactile information) to a user of electronic device 100. For example, I/O circuitry 110 may include any suitable output component or mechanism and can take a variety of forms, including, but not limited to, audio speakers, headphones, audio line-outs, visual displays, antennas, infrared ports, rumblers, vibrators, or combinations thereof.

In some embodiments, I/O circuitry 110 may include image display circuitry (e.g., a screen or projection system) as an output component for providing a display visible to the user. For example, the display circuitry may include a screen (e.g., a liquid crystal display (“LCD”), a light emitting diode (“LED”) display, an organic light-emitting diode (“OLED”) display, a surface-conduction electron-emitter display (“SED”), a carbon nanotube display, a nanocrystal display, any other suitable type of display, or combination thereof) that is incorporated in electronic device 100. As another example, the display circuitry may include a movable display or a projecting system for providing a display of content on a surface remote from electronic device 100 (e.g., a video projector, a head-up display, or a three-dimensional (e.g., holographic) display).

In some embodiments, display circuitry of I/O circuitry 110 can include a coder/decoder (“CODEC”) to convert digital media data into analog signals. For example, the display circuitry, or other appropriate circuitry within electronic device 100, may include video CODECS, audio CODECS, or any other suitable type of CODEC. Display circuitry also can include display driver circuitry, circuitry for driving display drivers, or both. The display circuitry may be operative to display content (e.g., media playback information, application screens for applications implemented on the electronic device, information regarding ongoing communications operations, information regarding incoming communications requests, or device operation screens) under the direction of processor 102.

It should be noted that one or more input components and one or more output components of I/O circuitry 110 may sometimes be referred to collectively herein as an I/O interface 110. It should also be noted that an input component and an output component of I/O circuitry 110 may sometimes be a single I/O component, such as a touch screen that may receive input information through a user's touch of a display screen and that may also provide visual information to a user via that same display screen.

Motion sensor 112 may include any suitable motion sensor operative to detect movements of electronic device 100. For example, motion sensor 112 may be operative to detect a motion event of a user carrying device 100. In some embodiments, motion sensor 112 may include one or more three-axis acceleration motion sensors (e.g., an accelerometer) operative to detect linear acceleration in three directions (i.e., the x or left/right direction, the y or up/down direction, and the z or forward/backward direction). As another example, motion sensor 112 may include one or more single-axis or two-axis acceleration motion sensors which may be operative to detect linear acceleration only along each of the x or left/right direction and the y or up/down direction, or along any other pair of directions. In some embodiments, motion sensor 112 may include an electrostatic capacitance (e.g., capacitance-coupling) accelerometer that is based on silicon micro-machined micro electromechanical systems (“MEMS”) technology, including a heat-based MEMS type accelerometer, a piezoelectric type accelerometer, a piezoresistance type accelerometer, or any other suitable accelerometer.

In some embodiments, motion sensor 112 may be operative to directly detect rotation, rotational movement, angular displacement, tilt, position, orientation, motion along a non-linear (e.g., arcuate) path, or any other non-linear motions. For example, if motion sensor 112 is a linear motion sensor, additional processing may be used to indirectly detect some or all of the non-linear motions. For example, by comparing the linear output of motion sensor 112 with a gravity vector (i.e., a static acceleration), motion sensor 112 may be operative to calculate the tilt of electronic device 100 with respect to the y-axis. In some embodiments, motion sensor 112 may alternatively or additionally include one or more gyro-motion sensors or gyroscopes for detecting rotational movement. For example, motion sensor 112 may include a rotating or vibrating element.

Processor 102 may include any processing circuitry operative to control the operations and performance of electronic device 100. For example, processor 102 may be used to run operating system applications, firmware applications, media playback applications, media editing applications, or any other application. In some embodiments, processor 102 may receive input signals from an input component of I/O circuitry 110 and/or drive output signals through an output component (e.g., a display) of I/O circuitry 110. Processor 102 may load a user interface program (e.g., a program stored in memory 104 or another device or server) to determine how instructions or data received via an input component of I/O circuitry 110 or one or more motion sensors 112 may manipulate the way in which information is provided to the user via an output component of I/O circuitry 110. Processor 102 may associate different metadata with any of the motion data captured by motion sensor 112, including, for example, global positioning information, a time code, or any other suitable metadata (e.g., the current mode of device 100 or the types of applications being run by device 100 when the motion data was captured).

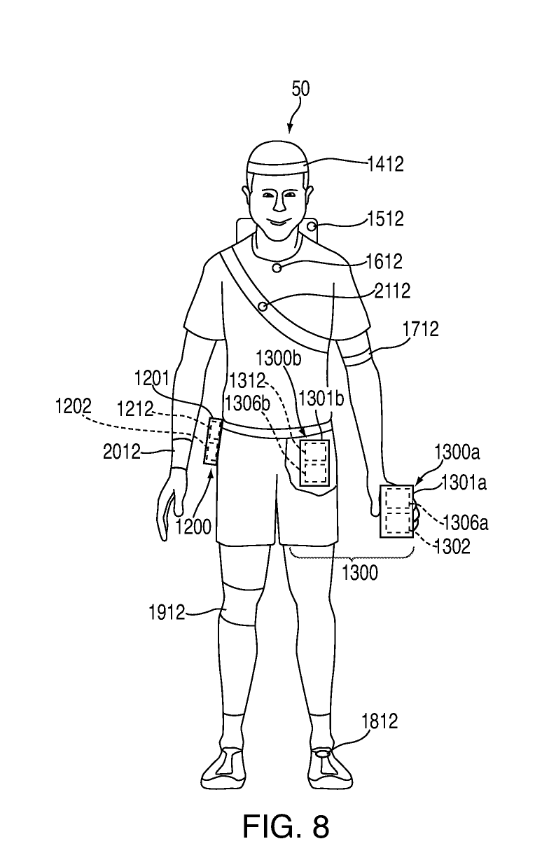

Electronic device 100 may also be provided with a housing 101 that may at least partially enclose one or more of the components of device 100 for protecting them from debris and other degrading forces external to device 100. In some embodiments, all of the components of electronic device 100 may be provided within the same housing 101. For example, as shown in FIG. 8, a user 50 may carry on his belt an electronic device 1200, which may be substantially similar to electronic device 100 of FIG. 1, that includes a single housing 1201 at least partially enclosing both a processor 1202 and a motion sensor 1212. In other embodiments, different components of electronic device 100 may be provided within different housings and may wirelessly or through a wire communicate with each other. For example, as shown in FIG. 2, user 50 may carry an electronic device 1300, which may be substantially similar to devices 100 and 1200, however electronic device 1300 may include a first device portion 1300a and a second device portion 1300b. Device portion 1300a may be held in the user's hand and may include a first housing 1301a at least partially enclosing processor 1302 and first communications circuitry 1306a, while device portion 1300b may be held in the user's pocket and may include a second housing 1301b at least partially enclosing motion sensor 1312 and second communications circuitry 1306b. In this embodiment, processor 1302 and motion sensor 1312 may communicate wirelessly or through a wire via first communications circuitry 1306a and second communications circuitry 1306b, for example.

User 50 may position motion sensors at various other locations with respect to his or her body besides hand, hip, and pocket. For example, as also shown in FIG. 8 user 50 may position motion sensors in any other suitable location, such as sensor 1412a on the user's head (e.g., in a headband), sensor 1512 in a user's accessory (e.g., in a back pack or other type of bag), sensor 1612 around the user's neck (e.g., in a necklace), sensor 1712 on the user's arm (e.g., in an arm band), sensor 1812 on the user's foot (e.g., in or on a shoe), sensor 1912 on the user's leg (e.g., in a knew brace), sensor 2012 on the user's wrist (e.g., in a watch), and sensor 2112 on the user's chest (e.g., in a strap of a bag), for example.

To enhance a user's experience interacting with electronic device 100, the electronic device may provide the user with an opportunity to provide functional inputs by moving the electronic device in a particular way. For example, motion sensor 112 may detect movement caused by a user motion event (e.g., a user shaking sensor 112 or walking with sensor 112) and sensor 112 may generate a particular motion sensor data signal based on the detected movement. The detected movement may include, for example, movement along one or more particular axes of motion sensor 112 caused by a particular user motion event (e.g., a tilting motion detected in a z-y plane, or a shaking motion detected along any of the accelerometer axes). Sensor 112 may then generate sensor data in response to the detected movement. Next, device 100 may analyze this generated motion sensor data for distinguishing a particular type of user motion event and for determining whether or not to perform a specific operation based on the distinguished type of user motion event (e.g., using rules or settings provided by an application run by processor 102).

Electronic device 100 may use any suitable approach or algorithm for analyzing and interpreting motion sensor data generated by motion sensor 112. Device 100 may analyze the motion sensor data to distinguish the type of user motion event that caused the movement detected by sensor 112 (e.g., by distinguishing between two or more different types of user motion event that may have caused the movement) and to determine whether or not to perform a specific operation in response to the distinguished type of user motion event. In some embodiments, processor 102 may load a motion sensing application (e.g., an application stored in memory 104 or provided to device 100 by a remote server via communications circuitry 106). The motion sensing application may provide device 100 with rules for utilizing the motion sensor data generated by sensor 112. For example, the rules may determine how device 100 analyzes the motion sensor data in order to distinguish the specific type of user motion event that caused the movement detected by sensor 112 (e.g., a user step event, a user shaking event, or perhaps an event not necessarily intended by the user (e.g., an unintentional or weak motion)). Additionally or alternatively, the rules may determine how device 100 handles the distinguished type of motion event (e.g., whether or not device 100 changes a function or setting in response to the distinguished event). Although the following discussion describes sensing motion in the context of a three-axis accelerometer, it will be understood that the discussion may be applied to any suitable sensing mechanism or combination of sensing mechanisms provided by motion sensor 112 of electronic device 100 for generating motion sensor data in response to detecting movement.

FIG. 2 is a schematic view of an illustrative accelerometer 200 that may be provided by motion sensor 112 of electronic device 100. Accelerometer 200 may include a micro electromechanical system (“MEMS”) having an inertial mass 210, the deflections of which may be measured (e.g., using analog or digital circuitry). For example, mass 210 may be coupled to springs 212 and 213 along x-axis 202, springs 214 and 215 along y-axis 204, and springs 216 and 217 along z-axis 206. As mass 210 is displaced along any of axes 202, 204, and 206, the corresponding springs may deflect and provide signals associated with the deflection to circuitry of the electronic device (e.g., circuitry provided by motion sensor 112 or any other suitable circuitry of device 100). Deflection signals associated with spring tension, spring compression, or both may be identified. Accelerometer 200 may have any suitable rest value (e.g., no deflection on any axis), including, for example, in free fall (e.g., when the only force on the accelerometer and the device is gravity). In some embodiments, the rest value may be continuously updated based on previous motion sensor data.

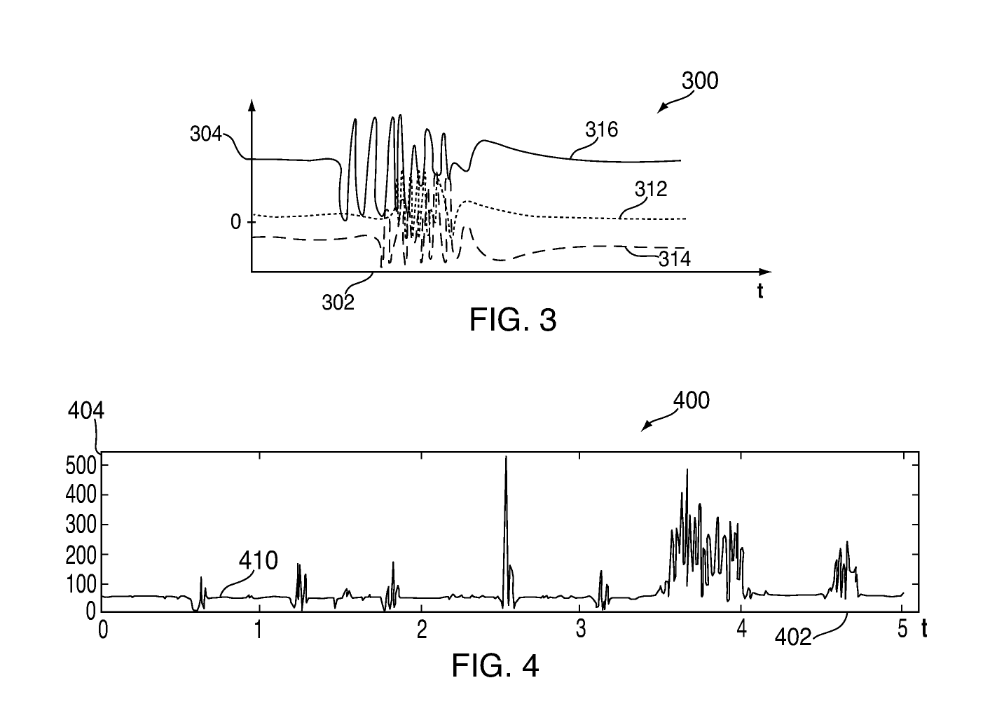

The electronic device may sample the accelerometer output (e.g., deflection values of mass 210) at any suitable rate. For example, the electronic device may sample accelerometer outputs in a range of 5 milliseconds to 20 milliseconds, such as 10 milliseconds. The rate may be varied for different springs and/or may be varied based on the current mode of the electronic device. The acceleration values detected by the accelerometer along each axis and output to circuitry of the electronic device may be stored over a particular time period, and for example plotted over time. FIG. 3 is a schematic view of an illustrative graph 300 of accelerometer output over time, according to some embodiments. For example, graph 300 may include time axis 302 and accelerometer value axis 304. The accelerometer value may be measured using any suitable approach, including, for example, as a voltage, force per time squared unit, or any other suitable unit. The value may be measured differently based on the current mode of the device. In some embodiments, the accelerometer may assign numerical values to the output based on the number of bits associated with the accelerometer for each axis. Graph 300 may include curve 312 depicting accelerometer measurements along the x-axis (e.g., of springs 212 and 213 of x-axis 202 of FIG. 2), curve 314 depicting accelerometer measurements along the y-axis (e.g., of springs 214 and 215 of y-axis 204 of FIG. 2), and curve 316 depicting accelerometer measurements along the z-axis (e.g., of springs 216 and 217 of z-axis 206 of FIG. 2).

Because a user may not always move an electronic device in the same manner (e.g., along the same axes), the electronic device may define, for each sampled time, an accelerometer value that is associated with one or more of the detected accelerometer values along each axis. For example, the electronic device may select the highest of the three accelerometer outputs for each sampled time. As another example, the electronic device may determine the magnitude of the detected acceleration along two or more axes. In one particular embodiment, the electronic device may calculate the square root of the sum of the squares of the accelerometer outputs (e.g., the square root of x²+y²+z²). As yet another example, the electronic device may define, for each sampled time, an accelerometer value for each of the detected accelerometer values along each axis. In some embodiments, the electronic device may ignore accelerometer outputs for a particular axis to reduce false positives (e.g., ignore accelerometer output along the z-axis to ignore the device rocking) when a condition is satisfied (e.g., all the time or when the accelerometer output exceeds or fails to exceed a threshold). In some embodiments, the electronic device may use several approaches to define several acceleration values associated with different types of detected movement (e.g., an acceleration value associated with shaking, a different acceleration value associated with spinning, and still another acceleration value associated with tilting). In some embodiments, the approach may vary based on the current mode of the electronic device. The electronic device may then analyze one or more of the acceleration values (i.e., one or more portions of the generated motion sensor data) to distinguish the type of user motion event that may be associated with the values (e.g., a user step event or a user shaking event) and to determine how to handle the distinguished type of motion event (e.g., whether or not device 100 changes a function or setting of the device in response to the distinguished event).

The resulting magnitude of the accelerometer output may be stored by the electronic device (e.g., in memory 104 or remotely via communications circuitry 106), and, for example, plotted over time. FIG. 4 is a schematic view of an illustrative graph 400 of the magnitude of the acceleration, according to some embodiments. For example, graph 400 may include time axis 402 and acceleration value axis 404. When substantially no acceleration is detected (e.g., when curve 410 is substantially flat), the magnitude of acceleration may be non-zero, as it may include acceleration due to gravity. This DC component in the magnitude of the acceleration signal may prevent the electronic device from clearly detecting only movements of the electronic device. This may be particularly true if the value of the DC component is higher than the value of peaks in the magnitude of the acceleration signal. In such a case, directly applying a simple low pass filter may conceal rather than reveal the acceleration signals reflecting movement of the electronic device.

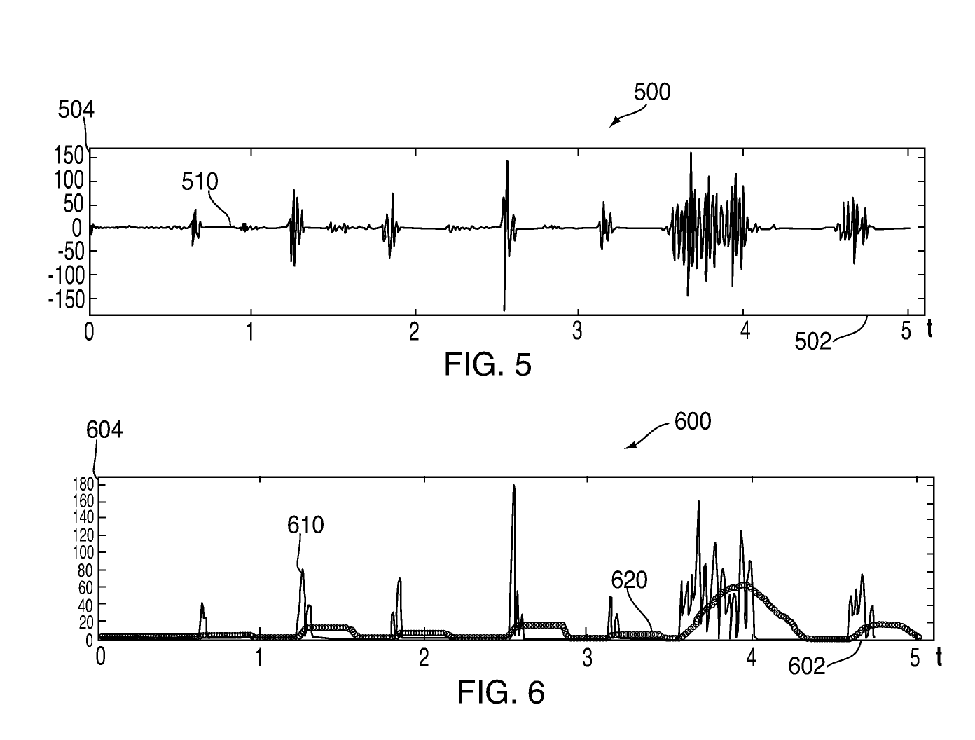

To remove the effects of gravity from the detected magnitude of acceleration signal, the electronic device may apply a high pass filter to the magnitude of the acceleration signal. The resulting signal may not include a DC component (e.g., because the high pass filter may have zero gain at DC) and may more precisely reflect actual movements of the electronic device. FIG. 5 is a schematic view of an illustrative graph 500 of the magnitude of acceleration after eliminating the effect of gravity, according to some embodiments. For example, graph 500 may include time axis 502 and acceleration value 504. Curve 510 may be substantially centered around a zero value (e.g., no DC signal reflecting constant gravity) and may include positive and negative peaks (e.g., potential lifting and landing event portions of a user's step event). In some embodiments, the electronic device may rectify the signal of curve 510 to retain only positive acceleration values. For example, the electronic device may use a full wave rectifier (e.g., to take the modulus of curve 510). FIG. 6 is a schematic view of an illustrative graph of the rectified magnitude of acceleration after eliminating the effect of gravity, according to some embodiments. For example, graph 600 may include time axis 602 and acceleration value 604. Curve 610 may reflect the modulus of each value of curve 510 (FIG. 5), and may thus be entirely above a zero acceleration value.

In some embodiments, the electronic device may then apply a low pass filter to the rectified signal to provide a smoother signal that may remove short term oscillations while retaining the longer term trend. For example, the electronic device may apply a low pass filter that computes a moving average for each sample point over any suitable sample size (e.g., a 32 point sample moving average). The resulting signal may be plotted, for example as curve 620. This signal may reflect how much the electronic device is moving (e.g., the value of each sample point may indicate the amount by which the device (i.e., the motion sensor) is moving).

Some or all of the filtering and/or some or all of the processing of the motion sensor data generated by motion sensor 112 (e.g., accelerometer 200) may be conducted by circuitry provided by motion sensor 112. Alternatively, some or all of the filtering and/or processing may be conducted by processor 102, for example. Using any version (e.g., processed or otherwise) of any portion of the motion sensor data generated by motion sensor 112 (e.g., any version of the accelerometer signal provided by accelerometer 200), electronic device 100 may determine whether or not to perform an operation or generate an event in response to the generated motion sensor data.

Electronic device 100 may perform any suitable operation in response to receiving particular motion sensor data from motion sensor 112 (e.g., using rules or settings provided by an application run by processor 102). For example, in response to sensor 112 detecting movement caused by a user's shaking motion event (e.g., a user shaking sensor 112) and then generating associated motion sensor data based on this detected movement, electronic device 100 may analyze the sensor data and may shuffle a media playlist, skip to a previous or next media item (e.g., song), change the volume of played back media, or perform any other suitable operation based on the analysis. In some embodiments, electronic device 100 may allow a user's specific movement of sensor 112 to navigate menus or access functions contextually based on currently displayed menus (e.g., on an output display component of I/O circuitry 110). For example, electronic device 100 may display a “Now Playing” display, navigate a cover flow display (e.g., display a different album cover), scroll through various options, pan or scan to a radio station (e.g., move across preset radio stations when in a “radio” mode), or display a next media item (e.g., scroll through images) based on the analysis of a particular motion sensor data signal generated by motion sensor 112 in response to motion sensor 112 detecting a particular movement caused by a user motion event (e.g., a shaking motion event or a tilting motion event).

In yet other embodiments, electronic device 100 may calculate exercise data based on the analysis of a particular motion sensor data signal generated by motion sensor 112. For example, in response to sensor 112 detecting a particular movement caused by a user's stepping motion event (e.g., a user walking or running with sensor 112) and then generating motion sensor data based on this detected movement, electronic device 100 (e.g., processor 102) may analyze this sensor data to distinguish the particular type of user motion event (e.g., a user step event) that caused the movement detected by sensor 112. In some embodiments, device 100 may distinguish the particular type of user motion event by distinguishing between two or more different types of user motion event that may have caused the movement. Based on this analysis, device 100 and may then determine how to handle the distinguished type of motion event (e.g., whether or not device 100 should record the step event (e.g., in memory 104) and make various “exercise” determinations based on the step event, such as the distance traveled by the user, the pace of the user, and the like). In some embodiments, electronic device 100 may then use these step event determinations to perform any suitable device operation, such as playing media having a tempo similar to the detected pace of the user.

Electronic device 100 may perform different operations in response to a particular motion sensor data signal based upon the current mode or menu of the electronic device. For example, when in an “exercise” mode (e.g., a mode in which electronic device 100 may generally use motion sensor 112 as a pedometer for detecting user step motion events), a particular motion sensor data signal generated by sensor 112 in response to detecting a specific movement may be analyzed by device 100 to distinguish a particular type of user step motion event, and various exercise determinations may be made based on the distinguished step motion event. However, when in a “navigational menu” mode (e.g., a mode in which electronic device 100 may generally use motion sensor 112 as a user command input for detecting user navigational motion events), the same particular motion sensor data signal generated by sensor 112 in response to detecting the same specific movement may be analyzed by device 100 to distinguish a particular type of user navigational motion event (i.e., not as a specific type of user step motion event). However, in other embodiments, electronic device 100 may analyze motion sensor data independent of the current mode or menu of the electronic device. For example, electronic device 100 may always shuffle a playlist in response to sensor 112 detecting a particular movement of the device, regardless of the application or mode in use when the movement is detected (e.g., shuffle a playlist in response to a shaking movement regardless of whether the device is in a “media playback” mode, an “exercise” mode, or a “navigational menu” mode). In some embodiments, the user may select particular motion events known by the electronic device (e.g., from a known library or based on events described by the template event data of motion sensor templates available to the device (as described in more detail below)) to associate different motion events with different electronic device operations and modes.

Changing the position of motion sensor 112 with respect to the user's body can negatively affect the ability of a user's particular motion event to consistently impart the same movement on sensor 112 for generating a particular motion sensor data signal to be used by device 100 for performing a particular operation. For example, whether or not device 100 is in an “exercise” mode, the movement detected by sensor 112 when the user is walking with sensor 112 in his hand may generally be different than the movement detected by sensor 112 when the user is walking with sensor 112 in his hip pocket (i.e., the motion of a user's hand while walking may generally be different than the motion of a user's hip while walking). Therefore, the motion sensor data generated by sensor 112 in response to detecting the movement imparted by the user walking with sensor 112 in his hand may generally be different than the motion sensor data generated by sensor 112 in response to detecting the movement imparted by the user walking with sensor 112 in his pocket, thereby potentially inducing electronic device 100 to respond differently despite the user motion event (i.e., walking) being the same.

Therefore, to promote consistent device operation in response to the same user motion event, despite varying the position of sensor 112 with respect to the user's body, electronic device 100 may be provided with one or more motion sensor templates. Each motion sensor template may include template sensor data similar to or otherwise associated with the particular motion sensor data that is expected to be generated by motion sensor 112 in response to sensor 112 detecting a particular type of movement caused by a particular user motion event with a particular sensor position.

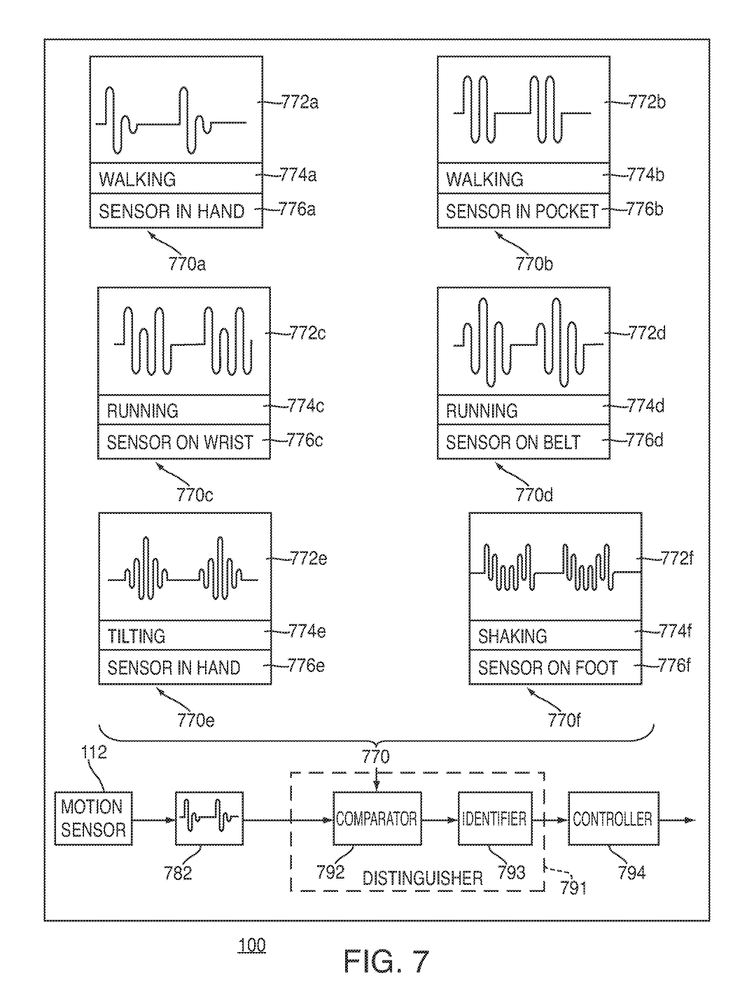

For example, as shown in FIG. 7, device 100 may be provided with motion sensor templates 770. Each motion sensor template 770 may include template sensor data 772 that is associated with the motion sensor data that sensor 112 of device 100 is expected to generate in response to sensor 112 detecting the movement imparted by a certain user motion event when the sensor is positioned in a certain location on the user's body. Each template 770 may also include template event data 774 that describes the certain user motion event associated with template sensor data 772 of that template 770. Additionally or alternatively, each template 770 may also include template position data 776 that describes the certain sensor position on the user's body associated with template sensor data 772 of that template 770.

Device 100 may be provided with motion sensor templates 770 that are associated with every possible sensor location on a walking user. For example, device 100 may be provided with a first motion sensor template 770a including first template sensor data 772a that is associated with the motion sensor data that sensor 112 is expected to generate in response to sensor 112 detecting the movement imparted by a user walking with sensor 112 positioned in the user's hand. Moreover, template 770a may also include template event data 774a describing the “walking” user motion event and template position data 776a describing the “sensor in hand” position associated with template sensor data 772a. As another example, device 100 may also be provided with a second motion sensor template 770b including second template sensor data 772b that is associated with the motion sensor data expected to be generated by sensor 112 in response to sensor 112 detecting the movement imparted by a user walking with sensor 112 positioned in the user's pocket. Moreover, template 770b may also include template event data 774b describing the “walking” user motion event and template position data 776b describing the “sensor in pocket” position associated with template sensor data 772b.

Additionally, device 100 may be provided with motion sensor templates 770 that are associated with every possible type of user exercise motion event (e.g., not just walking). For example, device 100 may be provided with a third motion sensor template 770c including third template sensor data 772c that is associated with the motion sensor data that sensor 112 is expected to generate in response to sensor 112 detecting the movement imparted by a user running with sensor 112 positioned on the user's wrist. Moreover, template 770c may also include template event data 774c describing the “running” user motion event and template position data 776c describing the “sensor on wrist” position associated with template sensor data 772c. As yet another example, device 100 may also be provided with a fourth motion sensor template 770d including fourth template sensor data 772d that is associated with the motion sensor data expected to be generated by sensor 112 in response to sensor 112 detecting the movement imparted by a user running with sensor 112 positioned on the user's belt. Moreover, template 770d may also include template event data 774d describing the “running” user motion event and template position data 776d describing the “sensor on belt” position associated with template sensor data 772d. A walking or running motion event, for example, may include any particular event that occurs during the process of a user walking or running. For example, a walking event may be a foot lifting event, a foot landing event, or a foot swinging event between lifting and landing events may be provided with its own template 770, or the entire event of a single foot lifting, swinging, and landing may be provided with a single template 770.

Moreover, device 100 may be provided with motion sensor templates 770 that are associated with every type of user motion event (e.g., navigational motion events, and not just those motion events associated with exercise or those motion events that may be expected when sensor 112 may be used as a pedometer when the device is in an exercise mode). For example, device 100 may be provided with a fifth motion sensor template 770e including fifth template sensor data 772e that is associated with the motion sensor data that sensor 112 is expected to generate in response to sensor 112 detecting the movement imparted by a user tilting sensor 112 when sensor 112 is positioned in the user's hand. Moreover, template 770e may also include template event data 774e describing the “tilting” user motion event and template position data 776e describing the “sensor in hand” position associated with template sensor data 772e. As another example, device 100 may also be provided with a sixth motion sensor template 770f including sixth template sensor data 772f that is associated with the motion sensor data expected to be generated by sensor 112 in response to sensor 112 detecting the movement imparted by a user shaking sensor 112 when sensor 112 is positioned on the user's foot. Moreover, template 770f may also include template event data 774f describing the “shaking” user motion event and template position data 776f describing the “sensor on foot” position associated with template sensor data 772f.

In some embodiments, each template 770 may contain several different template sensor data portions 772 provided at different data rates. This may enable the template sensor data 772 of a template 770 to be compared with motion sensor data no matter what the output data rate of the motion sensor may be. Moreover, in some embodiments, each template 770 may one or more different template sensor data portions 772, such as one sensor data portion stored in the time domain and another stored in the frequency domain.

In some embodiments, one or more motion sensor templates 770 may be created by a template provider (e.g., a manufacturer of device 100) and may then be made available to a user of device 100. For example, a sensor template 770 may be created by defining its template sensor data 772 as the data generated by a test motion sensor (e.g., a sensor similar to sensor 112) in response to receiving a movement generated by a test user acting out a user motion event defining template event data 774 while carrying the test sensor at a location defining template position data 776.

So that templates 770 of device 100 may include template sensor data 772 similar to motion sensor data expected to be generated in response to various types of expected users of device 100 (e.g., users of different heights and weights), various types of test users may each create template sensor data for a specific user motion event and for a specific sensor position. In some embodiments, the sensor data created by each specific type of test user for a specific combination of motion event and sensor position may be saved as its own template sensor data 772 in its own template 770. Alternatively, the template sensor data created by a specific type of test user for a specific combination of motion event and sensor position may be averaged or otherwise combined with the template sensor data created by other types of test users for the same specific combination of motion event and sensor position, and then saved as combined template sensor data 772 in a single “combined” template 770. Therefore, the data collected from multiple sensors for a specific motion event and a specific sensor location may be averaged or otherwise combined to create the sensor template to be provided on device 100.

Once template 770 has been created, it may be made accessible to device 100. For example, each of the created templates 770 may be stored in memory 104 of device 100 and then provided to the user. As another example, each of the created templates 770 may be loaded by the user onto device 100 from a remote server (not shown) via communications circuitry 106, such that the types of templates available to the device may be constantly updated by a provider and made available for download.

In some embodiments, one or more motion sensor templates 770 may be created by a user of device 100. For example, a user may position sensor 112 at various locations on the user's body and may conduct various user motion events for each of the locations. The motion sensor data generated by each of these events, along with the particular type of event and particular position of the sensor during the event, may be saved by device 100 as a motion sensor template 770 (e.g., in memory 104 or on a remote server via communications circuitry 106). For example, device 100 may have a “template creation” mode, during which device 100 may prompt the user to conduct one or more user motion events with sensor 112 positioned in one or more specific sensor locations such that device 100 may generate and save one or more motion sensor templates 770 to be accessed at a later time. Alternatively, after a user conducts a user motion event during normal use of the device, the user may provide information to device 100 (e.g., using an input component of I/O circuitry 110) indicating the type of motion event just conducted as well as the position of sensor 112 during that event, for example. Device 100 may then save this event and position information along with the motion sensor data generated by sensor 112 in response to detecting the movement of the motion event as a motion sensor template 770.

Regardless of the manner in which each motion sensor template 770 may be created, each sensor template 770 may include template sensor data 772 that defines a sensor data output profile associated with motion sensor data expected to be generated by sensor 112 of device 100 in response to a specific type of user motion event and a specific sensor position.

One or more motion sensor templates 770 may be used by device 100 to determine whether or not the motion sensor data generated by sensor 112 is sensor data that should cause electronic device 100 to perform a specific operation or generate a specific event. That is, one or more motion sensor templates 770 may be used by device 100 to determine whether or not specific sensor data should be recognized by device 100 as sensor data generated in response to sensor 112 detecting movement caused by a user motion event that may be used to control a function of the device.

For example, as shown in FIG. 7, when new motion sensor data 782 is generated by sensor 112, one or more motion sensor templates 770 may be used by device 100 to distinguish the type of user motion event that caused the movement detected by sensor 112. Device 100 may compare at least a portion of the generated motion sensor data 782 with at least a portion of template sensor data 772 from one or more of the motion sensor templates 770 accessible by device 100. In some embodiments, a comparator portion 792 of processor 102 or of any other component of device 100 may compare at least a portion of the generated motion data 782 (e.g., sensor data generated in response to a user's foot landing and/or lifting while walking with sensor 112) to at least a portion of template sensor data 772 from one or more of the motion sensor templates 770 available to device 100.

Device 100 may then perform an identification operation based on each of these one or more comparisons to attempt to identify a particular template 770 whose template sensor data 772 provides an acceptable or valid or successful match with generated motion data 782. In some embodiments, an identifier portion 793 of processor 102 or of any other component of device 100 may determine whether or not the comparison being made by comparator 792 between generated motion data 782 and the template sensor data 772 of a particular template 770 is a valid or acceptable or successful comparison. It should be noted that comparator 792 and identifier 793 may sometimes be referred to collectively herein as a distinguisher component 791. Distinguisher 791 may be a portion of processor 102 or of any other component of device 100 that may distinguish a particular template 770 based on the similarity between motion sensor data 782 and template sensor data 772 of the particular template 770. It is to be understood that motion sensor data 782 used by distinguisher 791 may be in any suitable form (e.g., may be filtered or otherwise processed in any suitable way before being used by distinguisher 791, including any of the forms described above with respect to FIGS. 3-6). Similarly, template sensor data 772 used by distinguisher 791 may be in any suitable form (e.g., may be filtered or otherwise processed in any suitable way before being used by distinguisher 791, including any of the forms described above with respect to FIGS. 3-6).

In some embodiments, device 100 may only compare generated motion sensor data 782 with template sensor data 772 from a subset of the motion sensor templates 770 accessible by the device. For example, when device 100 is in a particular mode (e.g., an “exercise” mode), device 100 may only do comparisons using template sensor data 772 from templates 770 associated with exercise motion events. That is, when device 100 is in an exercise mode, for example, device 100 may only compare generated motion sensor data 782 with template data 772 from those templates 770 having template event data 774 describing exercise motion events, such as “running” or “walking” (e.g., templates 770a-770d of FIG. 7), and not with template data 772 from those templates 770 having template event data 774 describing other types of motion events, such as “shaking” or “tilting” (e.g., templates 770e and 770f of FIG. 7). Alternatively, a user may tell device 100 where the sensor is positioned on the user's body (e.g., via an input component of I/O circuitry 110), and then device 100 may only compare generated motion sensor data 782 with template data 772 from those templates 770 having template position data 776 describing the sensor position provided by the user, such as “sensor in hand” (e.g., templates 770a and 770e of FIG. 7), and not with template data 772 from those templates 770 having template position data 776 describing other sensor positions, such as “sensor in pocket” (e.g., templates 770b-770d and 770f of FIG. 7). This may reduce the amount of comparisons processed by device 100 when in a certain device mode. In other embodiments, device 100 may compare generated motion sensor data 782 with template data 772 from all templates 770 accessible to device 100, regardless of the current mode or settings of device 100. In some embodiments, the user may select one or more particular motion events known by electronic device 100 (e.g., from a library of events described by the template event data 774 of all motion sensor templates 770 available to the device) and may associate those selected events with different electronic device operations and modes.

To distinguish a successful or acceptable match between template sensor data and motion sensor data, the comparison and identification provided by comparator 792 and identifier 793 can be carried out by correlating template data 772 of each template 770 separately against generated motion sensor data 782. The comparison can be carried out by cross-correlation. In other embodiments, the comparison may be conducted using other statistical methods, such as amplitude histogram features, can be used in the time domain, for example. Moreover, the comparison can also be based on shapes of template data 772 and sensor data 782, for example, using structural pattern recognition. In some embodiments, the comparison may be done in the frequency domain by comparing the frequency components of the template data and the frequency components of the sensor data.

Because user motion events, such as step motion events, may have variation between two similar steps, they may not start and end exactly at estimated moments. Therefore, cross-correlation or any other type of comparison between any portion of any set of template data 772 and any portion of sensor data 782 may be performed multiple times, and for each comparison the template data 772 and sensor data 782 may each be time shifted with respect to each other by a different offset. The phase shifts can be predetermined and may be small compared to the length of the data being compared or to a cycle length.

As shown in FIG. 8, for example, user 50 may carry multiple motion sensors on different parts of the body. Each part of the body may move uniquely with respect to other parts of the body. Therefore, the comparison may be improved by combining the results of several comparisons for each sensor 112 being carried by the user at a particular time. For example, at any given time, the user may be carrying three sensors 112, each of which may generate its own sensor data 782. Each of the three sets of generated motion sensor data 782 may be compared to the accessible templates 770. In such an embodiment, for example, in order to obtain a successful comparison for the user's specific motion event, each of the three comparisons must be successful.

When the similarity (e.g., correlation) is high enough between generated motion sensor data 782 and template data 772 of a specific template 770, the type of user motion event described by template event data 774 of that specific template 770 may be considered the type of user motion event that caused the movement detected by sensor 112 for generating motion sensor data 782. A similarity threshold may be defined and used by identifier portion 793 to determine whether the similarity value of the comparison is high enough to be considered a successful comparison. The similarity threshold may be defined by the user or by settings stored on the device. The similarity threshold may vary based on various conditions, such as the current mode of the device.

In some embodiments, if a similarity threshold is met by the similarity value of the first template comparison, for example, then the comparison may be considered a successful comparison and the comparison process may end. However, in other embodiments, even after a successful comparison has been identified (e.g., when the similarity value between the compared template data and sensor data meets a similarity threshold), the comparison process may still continue until all of the templates available to the comparison process have been compared with the generated motion sensor data. If more than one successful comparison has been identified during the comparison process, then the template whose similarity value exceeded the threshold the most (e.g., the template that has the most similarity with the generated sensor data), for example, may be identified as the distinguished template from the comparison process. If none of the comparisons made between generated motion sensor data 782 and template data 772 of each of the accessible templates 770 generates a similarity value meeting the similarity threshold, then the template whose similarity value is the greatest (e.g., the template that has the most similarity with the generated sensor data), may be identified as the distinguished template from the comparison process. Alternatively, if none of the comparisons made generates a similarity value meeting the similarity threshold, then device 100 may disregard generated motion sensor data 782 and may wait for new motion sensor data to be generated by motion sensor 112.

However, when device 100 determines during a comparison that at least a portion of generated motion sensor data 782 and at least a portion of template sensor data 772 from a specific one of motion sensor templates 770 are sufficiently similar, the template event data 774 from that template 770 may be accessed by device 100. For example, a controller portion 794 of processor 102 or of any other component of device 100 may access the template event data 774 of the particular sensor template 770 identified as a successful comparison by identifier portion 793 of device 100. Controller portion 794 may then use this specific template event data 774 to determine whether or not device 100 should perform a specific operation in response to the distinguished type of user motion event.

For example, if template event data 774 from the particular template 770 identified during the comparison describes a “walking” motion event, device 100 may be configured by controller portion 794 to record a user step (e.g., in memory 104) and update data regarding the distance walked by a user or data regarding the pace of the user. As another example, if template event data 774 from the particular template 770 identified during the comparison describes a “shaking” motion event, device 100 may be configured by controller portion 794 to shuffle a media playlist.

In some embodiments, controller portion 794 may not only use template event data 774 from the particular distinguished template 770 to determine whether or not device 100 should perform a specific operation, but may also use template position data 776 from the distinguished template 770 and/or information from generated motion sensor data 782.

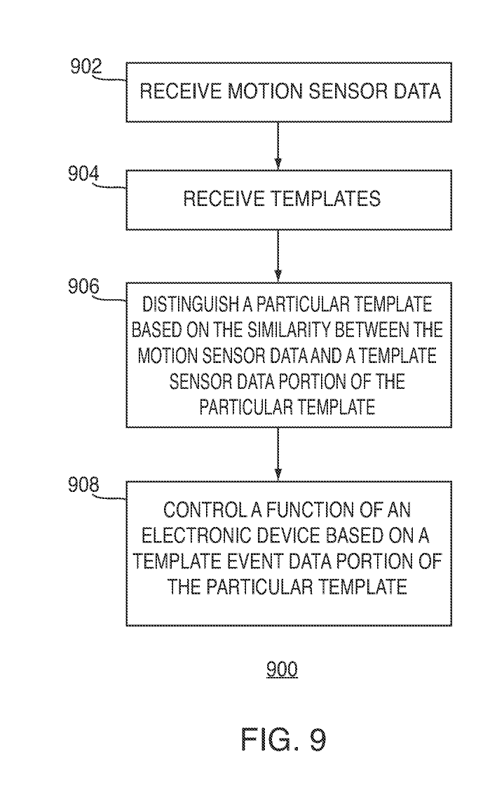

FIG. 9 is a flowchart of an illustrative process 900 for processing motion sensor data (e.g., to control an electronic device). At step 902, motion sensor data can be received. For example, the electronic device can include a motion sensor and the electronic device may receive motion sensor data generated by the motion sensor. The motion sensor data may be generated by the motion sensor in response to the sensor detecting a movement cause by a particular motion event (e.g., a user exercise motion event, a user navigational motion event, or a motion event not intentionally made by a user).

At step 904, one or more motion sensor templates can be received. For example, the electronic device can include local memory on which one or more motion sensor templates may be stored for use by the device. Additionally or alternatively, the electronic device may load one or more motion sensor templates from a remote server using communications circuitry of the device. Each motion sensor template may include a template sensor data portion and a template event data portion. The template sensor data portion may be associated with the motion sensor data that the motion sensor of the device is expected to generate in response detecting movement imparted by a certain motion event when the sensor is positioned in a certain location on a user's body. The template event data portion of the template may describe the certain motion event associated with the template sensor data of that template. Each template may also include a template position data portion that may describe the certain sensor position on the user's body associated with the template sensor data of that template.

Once the motion sensor data has been received at step 902 and once one or more motion sensor templates have been received at step 904, a particular motion sensor template may be distinguished at step 906. The particular template may be distinguished based on the similarity between the received motion sensor data and the template sensor data portion of the particular template. For example, this may be accomplished by comparing the received motion sensor data to the template sensor data portion of at least one template from a subset of all the templates received at step 904. Then, the particular template may be identified from the at least one template based on the comparison process.

In some embodiments, the subset of the templates used in the comparison process may only include each template received at step 904 that has a template event data portion related to a current mode of the electronic device. In some embodiments, the subset of the templates used in the comparison process may only include each template received at step 904 that has a template event data portion related to at least one type of exercise motion event, such as a walking event or a running event (e.g., a foot lifting event of a user walking or a foot landing event of a user running). In other embodiments, the subset of the templates used in the comparison process may only include each template received at step 904 that has a template event data portion related to at least one type of navigational motion event, such as a shaking event or a tilting event.

In some embodiments, the comparison process may determine a similarity value between the motion sensor data and the template sensor data portion of each template in the subset. This comparison process may involve comparing all or just a portion of the motion sensor data with all or just a portion of the template sensor data portion of the template. Additionally or alternatively, this comparison process may involve shifting the motion sensor data with respect to the template sensor data (e.g., by a predetermined offset). The identification process may then identify as the particular template the template in the subset having the greatest similarity value determined in the comparison process. Alternatively, the identification process may identify as the particular template the template in the subset having the similarity value that exceeds a similarity threshold value, for example.

Once a particular template has been distinguished at step 906, an operation or function of the device may be controlled based on the template event data portion of that particular template at step 908. For example, based on the certain motion event described by the template event data portion of the particular template, it may be determined whether or not the device should perform a specific operation. For example, if the template event data portion from the particular template distinguished at step 906 describes a “walking” motion event, the device may be configured to record the occurrence of a user step (e.g., in memory 104) and may update data regarding the distance walked by a user or may update data regarding the pace of the user at step 908. The device may then also be configured to present media to a user having a tempo similar to the pace of the user. As another example, if the template event data portion from the particular template distinguished at step 906 describes a “shaking” motion event, the device may be configured to shuffle a media playlist. In some embodiments, an operation or function of the device may be controlled at step 908 based not only on the template event data portion of the particular template distinguished at step 906 but also on at least a portion of the motion sensor data received at step 902. Additionally or alternatively, in some embodiments, an operation or function of the device may be controlled at step 908 based not only on the template event data portion of the particular template distinguished at step 906 but also the template position data portion of the particular template.

It is understood that the steps shown in process 900 of FIG. 9 are merely illustrative and that existing steps may be modified or omitted, additional steps may be added, and the order of certain steps may be altered.

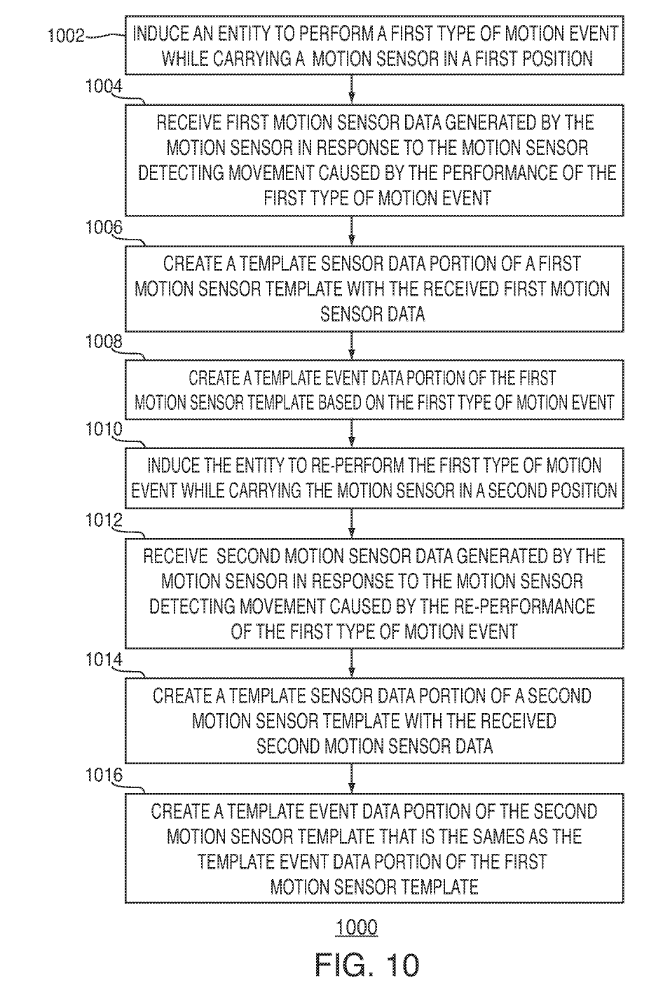

FIG. 10 is a flowchart of an illustrative process 1000 for generating motion sensor templates (e.g., templates as used in process 900 of FIG. 9). At step 1002, an entity may perform a first type of motion event while carrying a motion sensor in a first position. For example, the entity may be a human user or a model dummy that has moving parts substantially similar to a human user. In some embodiments, a human user may be prompted or otherwise induced by an electronic device to complete step 1002 (e.g., in response to instructions presented to a user by an output component of the device). Alternatively, the user may on its own accord complete step 1002.

First motion sensor data generated by the motion sensor in response to the motion sensor detecting movement caused by the performance of the first type of motion event at step 1002 may be received at step 1004. Then, at step 1006, a template sensor data portion of a first motion sensor template may be created with the first motion sensor data received at step 1004. The first motion sensor data received at step 1004 may be filtered or processed or otherwise manipulated before being used to create the template sensor data portion of the first motion sensor template at step 1006. At step 1008, a template event data portion of the first motion sensor template may be created based on the first type of motion event performed at step 1002. Additionally, in some embodiments, a template position data portion of the first motion sensor template may be created based on the first position of the sensor used at step 1002.

Next, at step 1010, the entity may re-perform the first type of motion event while carrying the motion sensor in a second position. Similarly to step 1002, in some embodiments, a human user may be prompted or otherwise induced by an electronic device to complete step 1010 (e.g., in response to instructions presented to a user by an output component of the device). Alternatively, the user may on its own accord complete step 1010.

Second motion sensor data generated by the motion sensor in response to the motion sensor detecting movement caused by the re-performance of the first type of motion event at step 1010 may be received at step 1012. Then, at step 1014, a template sensor data portion of a second motion sensor template may be created with the second motion sensor data received at step 1012. The second motion sensor data received at step 1012 may be filtered or processed or otherwise manipulated before being used to create the template sensor data portion of the first motion sensor template at step 1014. At step 1016, a template event data portion of the second motion sensor template may be created to be the same as the template event data portion of the first motion sensor template created at step 1008. Additionally, in some embodiments, a template position data portion of the second motion sensor template may be created based on the second position of the sensor used at step 1010.

The first type of motion event performed by the entity at step 1002 and then re-performed at step 1010 may be any suitable user motion event, such as any exercise motion event (e.g., a walking event or running event) or any navigational motion event (e.g., a shaking event or a tilting event). The first position of the sensor, as used in step 1002, may be any suitable position with respect to the entity at which the sensor may be carried. For example, if the entity is a human user, the first position may be any suitable position, including, but not limited to, in the user's hand, in the user's pocket, on the user's wrist, on the user's belt, on the user's foot, on the user's arm, on the user's leg, on the user's chest, on the user's head, in the user's backpack, and around the user's neck. The second position of the sensor, as used in step 1010, may also be any suitable position with respect to the entity at which the sensor may be carried, except that the second position should be different than the first position used in step 1002.

Step 1010 through step 1016 may be repeated for any number of different sensor locations while the entity re-performs the first type of motion event. Moreover, step 1002 through step 1016 may be repeated for any number of different types of motion events. This can increase the number of motion sensor templates available to the device and may increase the ability of the device to distinguish between one or more different types of motion events that could have caused a detected motion sensor data signal.

It is understood that the steps shown in process 1000 of FIG. 10 are merely illustrative and that existing steps may be modified or omitted, additional steps may be added, and the order of certain steps may be altered.

The processes described with respect to FIGS. 9 and 10, as well as any other aspects of the invention, may each be implemented by software, but can also be implemented in hardware or a combination of hardware and software. They each may also be embodied as computer readable code recorded on a computer readable medium. The computer readable medium may be any data storage device that can store data which can thereafter be read by a computer system. Examples of the computer readable medium include read-only memory, random-access memory, flash memory, CD-ROMs, DVDs, magnetic tape, and optical data storage devices. The computer readable medium can also be distributed over network-coupled computer systems so that the computer readable code is stored and executed in a distributed fashion.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The above-described embodiments of the invention are presented for purposes of illustration and not of limitation.

What is claimed is:

1. A method of controlling an electronic device comprising:
receiving motion sensor data;
accessing a plurality of templates, each template comprising template sensor data and template event data;
distinguishing a particular template of the plurality of templates based on the similarity between the motion sensor data and the template sensor data of the particular template; and
controlling a function of the electronic device based on the template event data of the particular template.

2. The method of claim 1, wherein the distinguishing comprises:
comparing the motion sensor data to the template sensor data of at least one template in a subset of the plurality of templates; and
identifying the particular template from the at least one template based on the comparing.

3. The method of claim 2, wherein the subset only comprises each template in the plurality of templates that comprises template event data related to a current mode of the electronic device.

4. The method of claim 2, wherein the subset only comprises each template in the plurality of templates that comprises template event data related to at least one of a plurality of exercise motion events.

5. The method of claim 4, wherein the plurality of exercise motion events comprises at least one of a walking event and a running event.

6. The method of claim 2, wherein the subset only comprises each template in the plurality of templates that comprises template event data related to at least one of a plurality of navigational motion events, and wherein the plurality of exercise motion events comprises at least one of a shaking event and a tilting event.

7. The method of claim 2, wherein the comparing comprises comparing at least a portion of the motion sensor data to at least a portion of the template sensor data of the at least one template.

8. The method of claim 2, wherein the comparing comprises shifting the motion sensor data with respect to the template sensor data of the at least one template by a predetermined offset.

9. The method of claim 2, wherein the comparing comprises determining a similarity value between the motion sensor data and the template sensor data of each template in the subset.

10. The method of claim 9, wherein the identifying comprises identifying as the particular template the template in the subset having the greatest similarity value.

11. The method of claim 9, wherein the identifying comprises identifying as the particular template the template in the subset having the similarity value that exceeds a similarity threshold value.

12. The method of claim 2, wherein the controlling comprises controlling the function of the electronic device based on both the template event data of the particular template as well as at least one of the motion sensor data and template position data of the particular template.

13. The method of claim 1, wherein the accessing the plurality of templates comprises at least one of loading at least a portion of the plurality of templates onto the electronic device from a remote server and loading at least a portion of the plurality of templates from memory local to the electronic device.

14. A method of generating motion sensor templates comprising:
inducing an entity to perform a first type of motion event while carrying a motion sensor in a first position;
receiving first motion sensor data generated by the motion sensor in response to the motion sensor detecting movement caused by the performance of the first type of motion event;
creating a template sensor data portion of a first motion sensor template with the received first motion sensor data; and
creating a template event data portion of the first motion sensor template based on the first type of motion event.

15. The method of claim 14, further comprising creating a template position data portion of the first motion sensor template based on the first position.

16. The method of claim 14, further comprising:
inducing the entity to re-perform the first type of motion event while carrying the motion sensor in a second position;
receiving second motion sensor data generated by the motion sensor in response to the motion sensor detecting movement caused by the re-performance of the first motion event;
creating a template sensor data portion of a second motion sensor template with the received second motion sensor data; and
creating a template event data portion of the second motion sensor template that is the same as the template event data portion of the first motion sensor template.

17. The method of claim 16, further comprising creating a template position data portion of the second motion sensor template based on the second position.

18. The method of claim 16, wherein:
the entity is a human user;
the first type of motion event is one of walking, running, shaking, and tilting;
the first position is any one of the following positions: in the user's hand, in the user's pocket, on the user's wrist, on the user's belt, on the user's foot, on the user's arm, on the user's leg, on the user's chest, on the user's head, in the user's backpack, and around the user's neck; and
the second position is any one of the following positions except the following position that is the first position: in the user's hand, in the user's pocket, on the user's wrist, on the user's belt, on the user's foot, on the user's arm, on the user's leg, on the user's chest, on the user's head, in the user's backpack, and around the user's neck.

19. An electronic device comprising:
a motion sensor; and
a processor configured to:
receive motion sensor data generated by the motion sensor;
access a plurality of templates, each template comprising template sensor data and template event data;
distinguish a particular template of the plurality of templates based on the similarity between the received motion sensor data and the template sensor data of the particular template; and
controlling a function of the electronic device based on the template event data of the particular template.

20. Computer readable media for controlling an electronic device, comprising computer readable code recorded thereon for:
receiving motion sensor data generated by a motion sensor of the electronic;
accessing a plurality of templates, each template comprising template sensor data and template event data;
distinguishing a particular template of the plurality of templates based on the similarity between the received motion sensor data and the template sensor data of the particular template; and
controlling a function of the electronic device based on the template event data of the particular template.
